(19) United States
(12) Patent Application Publication
(10) Pub. No.: US 2005/0230068 A1
(43) Pub. Date: Oct. 20, 2005

(54) Foamed plastic sliding screen door

(76) Inventors: Guerry E. Green, Pawleys Island, SC (US); Robert T. Hokum JR., Mt. Pleasant, SC (US)

Correspondence Address: MICHAEL A. MANN;NEXSEN PRUET, LLC, POST OFFICE DRAWER 2426, COLUMBIA, SC, 29202-2426, US

(21) Appl. No.: 11/107,462

(22) Filed: Apr. 15, 2005

Related U.S. Application Data
(60) Provisional application No. 60/563,390, filed on Apr. 19, 2004.

(51) Int. Cl. E05D 13/00

(52) U.S. Cl. 160/371

(57) ABSTRACT

A sliding plastic screen door made of foamed vinyl can be trimmed at the job site to fit the door it will occupy. The door may have reinforcing in its styles and potentially also in its rails but not in the top portion of the rail, which is where it may be cut to fit. Two embodiments are disclosed, one with a header that can be removed prior to trimming the top rail, and the other with a deep slot for the rollers, which top rail can be trimmed directly and the wheels reattached.

### CROSS REFERENCE TO RELATED APPLICATIONS:

The priority benefit of U.S. provisional application Ser. No. 60/563,390 filed Apr. 19, 2004 is claimed.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates to sliding screen doors.

Sliding doors are common in more contemporary homes. Many of these doors are multi-element doors and include a screen door which is simply a screens mounted to a sliding frame, typically a metal frame and most commonly, an aluminum frame. The size of these doors varies considerably, each manufacturer having its own range of sizes. Accordingly, when sliding doors need to be replaced, the size of the replacement door is a concern. Most manufacturers of after-market sliding doors provide some mechanism for adjusting the height of their replacement door at the time of installation.

Plastics are being used with increasing frequency as replacements for wood and metal and even ceramic materials. In construction, plastic piping has replaced some metal and ceramic piping. Vinyl shutters have replaced wood and aluminum shutters. Foamed plastic, particularly foamed vinyl, has found uses in molding and screen doors. Foamed vinyl is especially attractive as a substitute for wood because it can be trimmed with ordinary wood-working tools and techniques.

There are problems with foamed vinyl, of course, particularly when used on the exterior of a residence or office building where it is exposed to the sun. Heat from the sun tends to cause it to expand, only to contract when the sun sets. Repeated cycles of expansion and contraction may result eventually in deformation

Sliding doors are actually misnamed. While they appear to slide, they actually have small diameter wheels at the top and bottom that roll on tracks installed on the framing at the top and bottom of the opening they close. The tracks have low relief, perhaps a quarter inch at most. Thus, the fit of the door must be fairly precise so that these small wheels ride comfortably on these short tracks. A door that cannot be easily made to fit or that deforms over time would obviously not be suitable for such a purpose

Nevertheless, there remains a need for replacement sliding screen doors that are easily adjusted to the size needed and remain dimensionally stable over time.

### SUMMARY OF THE INVENTION

The present invention is a sliding screen door having a frame made of plastic, preferably foamed plastic. The top and bottom rails (which are horizontal members) of the doorframe are easily trimmed using standard woodworking tools and techniques. The stiles (which are vertical members) of the doorframe may be reinforced so that they do not appreciably deform during the life of the door.

A feature of the present invention is the use of foamed plastic, with foamed vinyl preferred. Foamed vinyl is durable, requires no painting, is easily washable, and is lightweight and relatively inexpensive compared to aluminum and many types of wood.

Another feature of the present invention is the simplicity with which the sliding screen door can be adjusted to fit the framed opening at the job site. The top rail can be trimmed quickly, easily and precisely with a circular saw for example to the height required.

Still another feature of the present invention is the combination of reinforcing to the stiles in order to reduce deformation and add strength to a sliding screen door of foamed vinyl, so that the door operates smoothly on the sliding door tracks. The door is also light-weight so that it is easy to slide.

Other features and their advantages will become readily apparent to those skilled in the art of construction materials from a careful reading of the Detailed Description of Preferred Embodiments, accompanied by the drawings.

### BRIEF DESCRIPTION OF THE DRAWINGS

In the drawings,

FIG. 1 is a perspective view of a corner of a sliding screen door, according to a preferred embodiment of the present invention;

FIG. 2 is a perspective view of a corner of the sliding screen door of FIG. 1, according to a preferred embodiment of the present invention;

FIG. 3 is a perspective view of a corner of an alternate sliding screen door, according to a preferred embodiment of the present invention;

FIG. 4 is a perspective view of a corner of the sliding screen door of FIG. 3, according to a preferred embodiment of the present invention.

### DETAILED DESCRIPTION OF PREFERRED EMBODIMENTS

The present invention is a sliding screen door having a frame made of plastic, preferably foamed plastic, and most preferably of foamed vinyl. Other materials may be added, such as wood flour and coloring agents, provided that they do not significantly alter the ability of the user to trim the screen door using wood-working tools and techniques.

Additionally, in a preferred embodiment, stiffening is added to the stiles and potentially also to the rails of the present screen doorframe, in order to reduce deformation that might otherwise result from exposure to heat. Stiffening added to stiles, which, being the long, vertical elements of the sliding doorframe, are the most susceptible to heat-related deformation, will have no impact on the ability of the user to trim the rails to fit, provided that the rails run the full width of the door and the stiles do not run the full height. Moreover, stiffening added to the rails, especially if confined to the lower portion of the top rail, will have only a minor impact on the ability of the user to trim the door to fit; that is, it will limit the extend to which the upper rail can be trimmed.

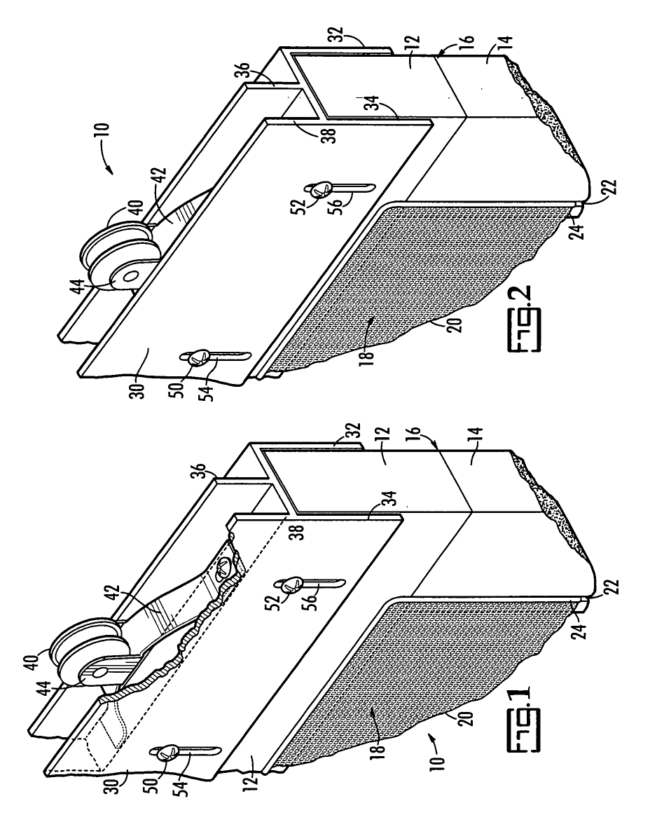

Referring now to the figures, FIGS. 1 and 2 show a first embodiment of the present invention, namely the corner of a sliding screen door made according to a preferred embodiment of the present invention. The corner shown, namely the top right corner, is typical of the other four comers (top left, bottom left, and bottom right). In particular, the door, generally indicated by reference number 10, includes a top rail 12 and an opposing bottom rail (not shown but symmetric with top rail 12) and a right stile 14 and an opposing left stile (not shown) that are joined at 16 to form a generally rectangular frame that defines an opening 18. Opening 18 is covered with screen material 20 fitted into a spline groove 22 and held in place with a spline 24.

Across top rail 12 is a header 30 formed with two legs 32 and 34 that straddle top rail 12 and arms 36 and 38 that serve to hold in alignment plural wheels 40 (one shown) with their axes horizontal so that they can ride a track (not shown) at the top and bottom of an opening, allowing door 10 to slide freely to the left and right. Wheels 40 are held between arms 36 and 38, by leaf springs 42 attached to header 30 and a yoke 44 that holds wheel 40. Wheels on bottom rails are held rigidly, as is well known in the prior art.

Header 30 is held to top rail 12 by screws 50 and 52 that extend through slots 54 and 56 formed in header 30. For major adjustments, screws 50 and 52 are removed and header 30 is slid off top rail 12. A portion of top rail 12 is trimmed away using, for example, a circular saw to remove a portion of top rail 12 and thereby shorten door 10. The header 30 is repositioned on top rail 12 and fastened with screws 50, 52. If fine adjustments in the location of header 30 are required, screws 50, 52 can be loosened and header moved slightly up or down as required. Then screws 50, 52, are retightened.

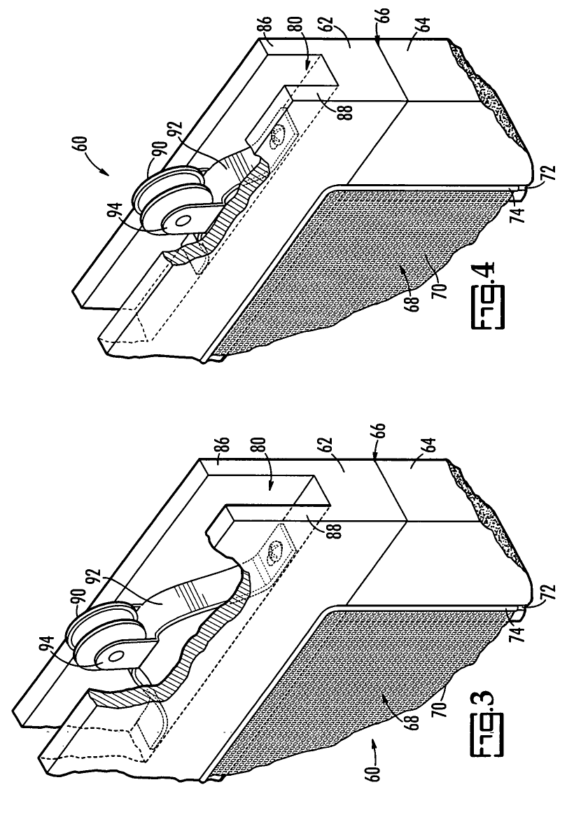

Referring now to FIGS. 3 and 4, there is shown a perspective view of a top right corner of an alternative embodiment of the present sliding screen door 60. Screen door 60 is symmetric left to right and top to bottom so that the top right corner is representative of the top left corner, the bottom left corner and the bottom right corner. Screen door 60 has a top rail 62 and an opposing bottom rail (not shown), a right stile 64 and an opposing left stile (not shown). The rails and stiles are joined together to form a rectangular frame that defines an opening 68. Screen material 70 is used to cover opening 68 and fastened to door 60 by forcing it into a spline groove 72 with a spline 74.

Instead of a header 30, in the embodiment shown in FIGS. 3 and 4, a deep groove 80 is milled in top rail 62 thereby defining members 86, 88, and wheels 90 (one shown) are mounted within groove 80, and held to members 86, 88, by leaf springs 90 (one shown) held within a yoke 94, in the same manner they are mounted between arms 36 and 38, namely, biased upwards by a leaf spring 42 attached to the bottom of groove 80 by a screw.

When screen door 60 must be trimmed to reduce its height, springs 90 are removed along with wheels 90. Then top rail 62 is cut using, for example, a circular saw to reduce the height of top rail 62. Groove 80, however, is deep enough so that even after removing a significant portion of top rail 62, groove 80 is still sufficiently deep so that it can accommodate wheels 90. Springs 92 are either bent to match the new depth of groove 80 or replaced with different springs 92 and refastened with screws to the bottom of groove 80.

The present screen door 10, 60, is designed to make it a simple matter to replace screen material 20, 70 by removing spline 24, 74, from spline groove 22, 74. New screen material 20, 70, can then be placed over opening 18, 68 and its edges reinserted into spline groove 22, 72, by pressing spline 24, 74, into groove 22, 72 over screen material 20, 70.

Stiles 14, 64, and rails 12, 62, can be made of solid plastic, hollow plastic, or foamed plastic, preferably vinyl, and they may be filled plastic, using for example, wood flour, or other materials to give it desirable properties or reduce costs, provided that the basic requirement of making top rail 12, 62 trimmable using standard woodworking tools and techniques is not compromised. Stiles 14, 64 may be made stiffer using metal bars inserts such as rods, tube, bars, or angled pieces around which the plastic is extruded. Other stiffening techniques may also be used.

It will be readily apparent that many substitutions and modifications can be made to the foregoing preferred embodiments without departing from the spirit and scope of the present invention, defined by the appended claim.

1. A sliding plastic screen door, comprising a foamed plastic frame including
a top rail,
a bottom rail,
a left stile, and
a right stile joined to form a rectangular frame defining a rectangular opening with a spline groove formed around the inside edge of said frame proximate said opening;
screen material covering said opening;
a spline securing said screen to said frame over said opening; and
a header removably attached to said top rail, said header carrying
at least two springs,
a yoke carried by each spring of said at least two springs, and
a wheel carried by each yoke.

2. The sliding plastic screen door as recited in claim 1, wherein said top rail has an upper portion and a lower portion, said lower portion of said top rail including reinforcing so that said upper portion can be cut away.

3. The sliding plastic screen door as recited in claim 1, wherein said header is attached with screws.

4. A sliding plastic screen door, comprising a foamed plastic frame including
a top rail,
a bottom rail,
a left stile, and
a right stile joined to form a rectangular frame defining a rectangular opening with a spline groove formed around the inside edge of said frame proximate said opening, said top rail having a groove formed therein;
screen material covering said opening;
a spline securing said screen to said frame over said opening;
at least two springs carried in said groove in said top rail;
a yoke carried by each spring of said at least two springs; and
a wheel carried by said each yoke.

5. The sliding plastic screen door as recited in claim 4, wherein said groove in said top rail is made deep enough so that a portion of said top rail can be cut away, still leaving a groove for said at least two springs, in order to reduce the height of said sliding plastic screen door.
